(19) United States
(12) Patent Application Publication
(10) Pub. No.: US 2001/0033622 A1
(43) Pub. Date: Oct. 25, 2001

(54) Robust utilization of feedback information in space-time coding

(76) Inventors: George Jöngren, Otterstavagen (SE); Mikael Skoglund, Tullinge (SE)

Correspondence Address: Ronald L. Grudziecki, Esquire, BURNS, DOANE, SWECKER & MATHIS, L.L.P., P.O. Box 1404, Alexandria, VA, 22313-1404, US

(21) Appl. No.: 09/797,951

(22) Filed: Mar. 5, 2001

Related U.S. Application Data
(60) Provisional application No. 60/189,033, filed on Mar. 14, 2000.

(51) Int. Cl. H04B 7/06

(52) U.S. Cl. 375/267; 375/358

(57) ABSTRACT

Side information in the form of quantized channel feedback information is utilized to improve an orthogonal space-time block code by means of a linear transformation. The feedback link utilizes COVQ quantization in order to provide the transmitter with an estimate of the current channel realization. The channel realization estimate, together with reliability information, is then used in the transmission scheme for determining the appropriate linear transformation. The result is a system which effectively combines conventional transmit beamforming with orthogonal space-time block coding, thereby providing a scheme which is more robust with respect to the errors that originate from the noise in the feedback channel.

### FIELD OF THE INVENTION

The present invention relates to the field of spatial diversity in a communications system, and more particularly to the use of quantized feedback information in space-time coding.

### BACKGROUND

One way to obtain higher data rates in wireless communication systems is to exploit the spatial dimension by using antenna arrays at both the transmitter and receiver. The high data rates that these multi-input multi-output (MIMO) systems may offer have been demonstrated, for example, by Foschini et al., assuming a flat Rayleigh fading channel model and no channel information at the transmitter, in “On Limits of Wireless Communications in a Fading Environment when Using Multiple Antennas” Wireless Personal Communications, vol.6, pp.311-335, March 1998. Based on the same model, space-time codes have been developed that utilize both the spatial and the temporal dimension to achieve a large portion of the available capacity. For example, the space-time codes disclosed by Tarokh et al. in “Space Time Codes for High Data Rate Wireless Communication: Performance Criterion and Code Construction” IEEE Transactions on Information Theory, vol.44, pp.744-765, March 1998, or “Space-Time Block Codes from Orthogonal Designs” IEEE Transactions on Information Theory, vol.45, pp. 1456-1467, July 1999.

Alternatively, it is reasonable in some communication systems to assume that channel information at the transmitter is available. Examples of such systems are time division duplex (TDD) systems and/or communication systems with a feedback link. In the former case, the channel can be estimated in the receive mode and then assumed to be the same for the transmission mode whereas for the latter case channel estimates are obtained at the receiver and then transported over a dedicated feedback link to the transmitter.

Space-time coding, as mentioned above, is one approach to exploiting the spatial domain. For example, the open loop mode standardized in WCDMA, known as space-time transmit diversity (STTD). In open loop schemes, no feedback information from the terminal (i.e., the receiver) is used in the base station. Instead, an encoding scheme exploiting the spatial diversity is utilized at the transmitter. The encoding can be seen as a generalization of traditional error correcting codes to more than one antenna.

Another approach, mentioned above, is the closed loop or feedback scheme. In a typical closed loop transmit diversity scheme, such as the two closed loop modes in WCDMA, the terminal regularly reports one or several received signal measurements back to the base station (i.e., the transmitter). The base station uses this feedback information to adjust the amplitude and/or phase of the signals transmitted from the different antennas in order to maximize some quantity, typically the received signal-to-noise ratio in the terminal. Naturally, these schemes require that the feedback information is accurate and up to date.

It is known that a transmitter having knowledge of the instantaneous channel conditions as seen by the receiver can utilize this information in order to improve performance compared to transmitters which do no have this side information. There are several different ways of exploiting this side information, for example, mobile assisted beamforming using adaptive arrays, and/or the closed loop transmit diversity schemes standardized in WCDMA. Information regarding the current channel conditions (i.e., the side information) is obtained by having the receiver feed back information from its channel estimator to the transmitter. However, since the transmitter trusts the information obtained from the receiver, such schemes can be sensitive to errors in the feedback channel.

As long as the feedback information is of sufficiently high quality, for example, the bit error probability is sufficiently low, the feedback schemes typically out perform the non-feedback schemes. However, as the non-feedback or open loop schemes do not utilize feedback information, they are generally more robust in presence of low quality feedback information.

The quality of the feedback information is affected by several factors. For example, the quality of feedback information can be affected by quantization of the information, feedback delay and/or bit errors in the feedback loop. While quantization of the side information naturally causes a loss of information, the feedback information must be quantized before being fed back due to the bandwidth of the feedback channel being a premium. A feedback delay in conjunction with a time varying channel can result in feedback information which is outdated by the time it arrives at the transmitter. Furthermore, the feedback channel is subject to disturbances which can result in bit errors, which also degrades the quality of the feedback information. While conventional error correcting coding may overcome some of the feedback quality issues, it requires excess bandwidth and causes additional delays in the decoding process. Therefore, a need exists to find an approach to exploitation of the spatial domain, which achieves the performance of the feedback approach and the robustness of the non-feedback approach.

### SUMMARY OF THE INVENTION

As a solution to the above described problems a method and apparatus for achieving spatial diversity is provided which combines the use of quantized feedback information with traditional space-time coding.

In exemplary embodiments, space-time coding sequences are weighted based on the feedback information received from the receiver. Accordingly, the present invention combines the potential performance (depending on the quality of the feedback information) of a closed loop transmit diversity scheme with the robustness of an open loop space-time coding scheme.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram of a space-time coding system according to an embodiment of the present invention;

FIG. 2 shows the probability of a symbol error as a function of the SNR using a system in accordance with the present invention; and

FIG. 3 shows a comparison between a system according to the present invention and conventional beamforming schemes in the case of a noisy feedback channel.

### DETAILED DESCRIPTION OF THE INVENTION

In the following description, for purposes of explanation and not limitation, specific details are set forth, such as particular algorithms, circuit components, techniques, steps etc. in order to provide a thorough understanding of the present invention. However, it will be apparent to one of ordinary skill in the art that the present invention may be practiced in other embodiments that depart from these specific details. In other instances, detailed descriptions of well-known methods, devices, and circuits are omitted so as not to obscure the description of the present invention with unnecessary detail.

These and other aspects of the invention will now be described in greater detail in connection with exemplary embodiments. To facilitate an understanding of the invention, many aspects of the invention are described in terms of sequences of actions to be performed by elements of a computer system. It will be recognized that in each of the embodiments, the various actions could be performed by specialized circuits, by program instructions being executed by one or more processors, or by a combination of both. Moreover, the invention can additionally be considered to be embodied entirely within any form of computer readable storage medium having stored therein an appropriate set of computer instructions that would cause a processor to carry out the techniques described herein. Thus, the various aspects of the invention may be embodied in many different forms, and all such forms are contemplated to be within the scope of the invention.

The present invention combines traditional space-time coding techniques with a weighting function, wherein the weighting function is based on the feedback information received from the receiver.

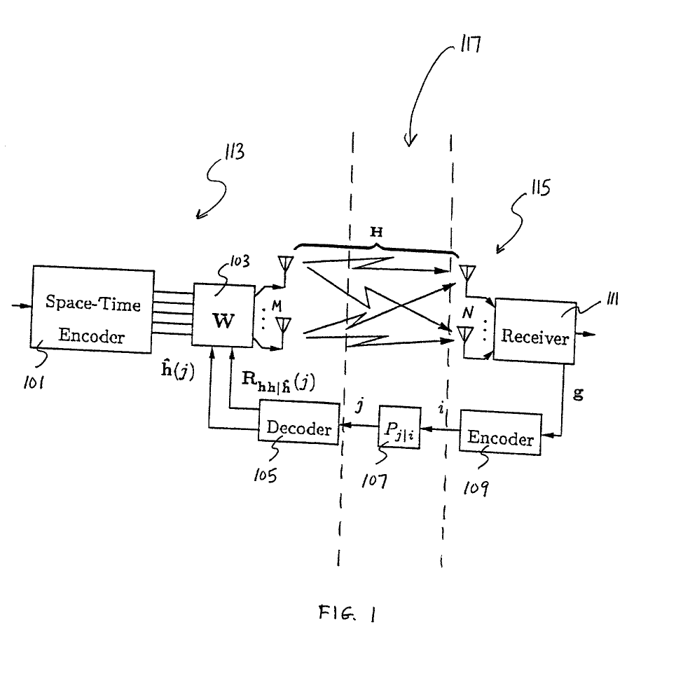

A block diagram of a system 117 according to an exemplary embodiment of the present invention is illustrated in FIG. 1. The system 117 has M transmit and N receive antennas. The channels between the transmitter and receiver are represented by the elements of the matrix H (or h, which contains the same information as H). A space-time encoder 101 maps the data to be transmitted into codewords that are split into M parallel and generally different symbol sequences. In the receiver 111, g represents the initial channel information that is to be conveyed over the feedback link. In order to utilize the available channel information at the transmitter 113, a linear transformation of the codeword is performed. The linear transformation is represented by the matrix W which is determined so that the probability of a codeword error at the receiver is reduced. The result of the linear transformation is a new set of parallel symbol sequences which are first pulse shaped and then transmitted. At the receiver 111, perfect channel estimation is assumed and maximum likelihood (ML) decoding is performed in order to recover the transmitted data.

The initial channel information g is transferred to the transmitter 113 using b bits and, consequently, some kind of quantization is needed. In the transmitter 113, the b bits received on the feedback channel, some of which can be in error, are decoded, resulting in the quantities ĥ and R_{hh|ĥ}−(j) . Here j is an integer formed from the b received bits. Information about the channel realization is contained in ĥ(j), whereas R_{hh|ĥ}−(j) is a measure of the reliability/quality of ĥ(j). These quantities are subsequently used in the determining the transmitter weighting W. In the examplary embodiment the determination of the quantities ĥ and R_{hh|ĥ}−(j) is based on the hard-decision statistic j. Alternatively, soft information available at the output of the feedback channel can be utilized to increase the resolution in determining these quantities. The transmitter weights can be determined according to several techniques. According to an exemplary embodiment, a criterion minimizing the upper bound of the pairwise error probability is used.

The information carrying signals are transmitted over a wireless fading channel. The time dispersion introduced by the channel is assumed to be short compared with the symbol period. Therefore, the individual channel between each transmit and receive antenna may be modeled as flat fading. The model used for the filtered and symbol sampled received baseband equivalent signal is then given by

x(n)=H* c(n)+e(n)

where (.)* denotes the complex conjugate transpose and where the linearly transformed symbols, transmitted from the M antennas at the time instant n, are represented by

c(n)=[c₁(n)c₂(n) . . . c_{M}(n)]^{T}=W\overline{c}(n)

As seen, the corresponding output from the space-time encoder is denoted by \overline{c}(n). The noise term e(n) is assumed to be temporally and spatially white complex Guassian with covariance matrix σ²I_{N}, where I_{N} denotes the N×N identity matrix. Furthermore, the MIMO channel is represented by the matrix H with elements hᵢⱼ, such that the channel between the i^{th} transmit antenna and the j^{th} receive antenna is h*ᵢⱼ.

A quasi-static scenario is considered where the channel is assumed to be constant during the transmission of a codeword but may vary from one codeword to another in a statistically stationary fashion. In order to obtain a general description of the statistics of the fading, the columns of H are stacked in a vector h=vec(H). This vector is assumed to be zero-mean complex Gaussian distributed with a covariance matrix Rₕₕ.

The feedback link provides the transmitter 113 with estimates of the current channel realization. In a typical system employing a feedback link, the data rate over that link must be kept at a minimum in order for the whole system to be spectrally efficient. This often means that the channel estimates must be heavily quantized. Another aspect concerns the errors introduced by the feedback channel itself. Accordingly, the exemplary embodiment of the present invention employs the use of vector quantization designed for a noisy channel.

Errors in the feedback information can cause a performance loss. One way of suppressing the influence of an imperfect feedback channel is to protect the feedback bits with an error correcting code. The feedback bits are obtained by quantizing the feedback information. Possible drawbacks with this approach are the cost in bandwidth due to the expansion of the feedback information and the delays due to decoding of the error correcting code.

Another approach to suppressing the influence of an imperfect feedback channel is to combine the quantization and error protection. According to the present invention, a channel optimized vector quantizer (COVQ) is suggested, as it provides an optimal, in the MMSE sense, transmission of the feedback information given a limited number of bits. The reliability of the bits received over the feedback channel can be estimated from the BER and FER of the associated uplink data channel.

Quantization in the feedback link limits the data rate needed to convey the channel coefficients. The errors in the channel information that reach the transmitter are due to several factors. Both the quantization procedure and the noise in the feedback channel contribute. Another source of error originates from the assumption of a feedback delay which means that the channel coefficients are, due to channel variations, (more or less) outdated when they reach the transmitter. The present invention slightly modifies the channel optimized vector quantization (COVQ) in order to mitigate the detrimental consequences of these errors. The remaining errors are taken into account by the transmission scheme which determines a linear transformation that improves a predetermined space-time code.

Typically there is a delay in the feedback link which means that the channel information at the transmitter may be outdated due to variations of the MIMO channel during the delay. Thus, when the transmitter receives the channel coefficients, they correspond to an old channel realization. The present invention accounts for this behavior by assuming that the channel coefficients that the receiver transmits over the feedback link are correlated (to an arbitrary degree) with the true channel. Numerical examples show significant gains using the setup of the present invention compared with systems which tentatively assume the channel information at the transmitter to be perfect.

As seen in FIG. 1, the vector g, with the corresponding channel coefficients gᵢⱼ, represents the outdated realization of h that is transmitted over the feedback link. Further, g is assumed complex Gaussian and represents the side information prior to quantization. The quality of this initial side information is determined by its degree of correlation with h. The correlation properties are assumed to be described by the cross-covariance matrix R_{hg} and the covariance matrix R_{gg}. The source input to the encoder is thus a MN-dimensional complex valued vector g.

Encoder 109 maps each input source vector to a finite set of discrete numbers. Since the feedback link uses b bits for the quantization, the encoder 109 is a mapping ε: ◖^{NM}→{0, . . . , 2^{b}−1}, such that ε(g)=i for a given source vector g. The mapping of the encoder is described by gεSᵢ→ε(g)=i, where the set of encoder regions {Sᵢ}ᵢ₌₀²^{^{b}}₋₁ defines a partition of ◖^{NM}. The output of the encoder 109 is mapped into bits and transmitted over what is here modeled as a memoryless binary symmetric channel with bit error probability P_{b}. Based on this channel model, and the fact that an index corresponds to a group of b bits, it is straightforward to derive an equivalent channel. The resulting discrete memoryless multilevel channel is completely described by the set of transition probabilities {P_{j|}} define for all (i,j)ε{0, . . . , 2^{b}−1}².

The decoder 105 reconstructs the current channel realization based on the output from the feedback channel. More precisely, it performs the mapping δ:{0, . . . , 2^{b}−1}→◖^{NM} such that δ(j)=ĥ(j) for the discrete channel output j, where ĥ(j) represents an estimate of the current channel realization. The current channel realization is then utilized to optimize W, taking into account that ĥ(j) is a non-perfect estimate of the current channel realization.

The transmission scheme of the present invention can be used in various scenarios, for example, a simplified fading scenario. To illustrate how the present invention can be used, a simplified fading scenario is now discussed in which a rich scattering environment is assumed. Further, it is assumed that the antennas at both the transmitter 113 and the receiver 115 are spaced sufficiently far apart so that the fading is spatially independent. As is well known, other means of achieving such independent fading include the use of antennas with varying polarization properties. A reasonable model is to assume that the channel coefficients hᵢⱼ are independent and identically distributed (i.i.d.), zero-mean complex Gaussian with the variance σₕ². The coefficients of the outdated channel estimates gᵢⱼ are modeled in the same way. The quality of the initial side information is modeled by assuming that each outdated channel coefficient gᵢⱼ is correlated with the corresponding current channel coefficient hᵢⱼ, and uncorrelated with all others. A measure of the quality of these estimates is then the normalized correlation coefficient ρ=E[hᵢⱼgᵢⱼ*]/(σₕ²). If hᵢⱼ and gᵢⱼ are jointly Gaussian and zero-mean, the second order statistics of the true channel and the side information is thus completely characterized by the covariance matrices

Rₕₕ=σₕ²I_{MN′}R_{hg}=σₕ²I_{MN′}R_{gg}=σₕ²I_{MN}

Both the encoder 109 and the decoder 105 are optimized so that the total distortion is minimized. The total distortion includes contributions from both quantization and errors in the feedback channel. In addition, channel variations during the feedback delay also contribute. Therefore, the COVQ is modified so as to take the consequences of the channel variations into account, in the design of the encoder 109 and the decoder 105.

According to exemplary embodiments of the present invention, the classical mean-square error criterion for the VQ design is utilized. Therefore, the encoder 109 and the decoder 105 are considered optimal if,

D(ε, δ)=E[∥h−δ(j)∥²] (2)

is minimized with respect to the mappings defined by ε and δ. This is similar to the criterion generally used in COVQ literature except for the fact that the present invention attempts to reconstruct h as opposed to reconstructing the source output g. However, with the some straightforward modifications, equation (2) can be minimized using standard methods for training COVQ. For example, the COVQ can be trained using a variant of the well-known Lloyd algorithm. This algorithm alternates between optimizing the encoder while holding the decoder fixed, and optimizing the decoder while holding the encoder fixed, until convergence is achieved. In the present case, the optimal encoder, assuming the decoder is known and fixed (as defined by {ĥ(j)}), is given by

$$\begin{matrix}ε ( g ) = arg {min}_{i} E [ {‖ h - \hat{h} ( j ) ‖}^{2} \vert i , g ] \\ = arg {min}_{i} {\sum }_{j = 0}^{2 b - 1} {P}_{j \vert l} {‖ {m}_{h \vert g} - \hat{h} ( j ) ‖}^{2}\end{matrix} \qquad ( 3 )$$

where m_{h|g}=R_{hg}R_{gg}⁻¹g is the minimum mean-square error (MMSE) estimate of the current channel realization based on g. It can also be shown that the optimal decoder, given a known encoder (as described by the encoder regions {Sᵢ}), is given by

$$δ ( j ) = E [ h \vert j ] = {R}_{hg} {R}_{gg}^{- 1} {\sum }_{i = 0}^{{2}^{b} - 1} {P}_{i , j} E [ g \vert i ] \qquad ( 4 )$$

where E[g|i] represents the i^{th} encoder centroid. Here, P_{i|j} is easily derived from the feedback channel transition probabilities and the source output statistics. Equations (3) and (4) can be used when training the VQ. Note that the training can be performed offline.

As mentioned above, the transmission scheme utilizes the feedback information in performing a linear transformation of the space-time code. The details of the transmission scheme are now described.

Without loss of generality, it is assumed that the codewords are of length L and that a codeword \overline{C} is the output from the space-time encoder during the time interval n=0, . . . , (L−1) . The linear transformation then forms another codeword, represented by the M×L matrix

C=W\overline{C}=[c(o)c(1) . . . c(L−1)] (5)

where \overline{C} is the predetermined codeword and W is an M×M matrix, shared by all codewords. In order to limit the average output power, the constraint ∥W∥_{F}²=M is imposed, where ∥·∥_{F}² denotes the Frobenious norm. Furthermore, block orthogonal space-time codes are considered. These codes have the property that

(Cₖ−Cₗ)(CₖCₗ)*=μₖ₁I_{M′}∀k≠l (6)

where Cₖ and Cₗ are two arbitrary codewords and μₖₗ is a scaling factor which is seen to depend on the codeword pair. A performance criterion based on an upper bound of the worst pairwise error probability can be derived, for example, see the discussion by Jongren et al. in “Combining Transmit Antenna Weights and Orthogonal Space-time Block Codes by Utilizing Side Information” in Proc. 33th Asilonar Conference on Signals, Systems and Computers, October 1999, which is herein incorporated by reference in its entirety. The performance criterion can be written as

v(W)=m_{h|ĥ}R_{hh|ĥ}⁻¹ψ(W)⁻¹R_{hh|ĥ}⁻¹m_{h|ĥ}−log detψ(W) (7)

where ψ(W)=(I_{N}\mathring{X}WW*)μ_{MIN}/4σ²+R_{hh|ĥ}⁻¹, μₘᵢₙ is the minimum value of μₖₗ taken over all codeword pairs, m_{h|ĥ} is the mean of the current channel conditioned

on the channel side information, and R_{hh|ĥ} is the corresponding covariance matrix. The Kronecker product is denoted by \mathring{X}. For the problem at hand, it can be shown that

$${m}_{h \vert \hat{h}} = E [ h \vert j ] = \hat{h} ( j )$$

$$\begin{matrix}{R}_{hh \vert \hat{h}} = E [ ( h - {m}_{h \vert \hat{h}} ) {( h - {m}_{h \vert \hat{h}} )}^{*} [ j ] \\ = {R}_{hh \vert g} - \hat{h} ( j ) {\hat{h} ( j )}^{*} + \\ {R}_{hg} {R}_{gg}^{- 1} {\sum }_{i = 0}^{{2}^{b} - 1} {P}_{i \vert j} E [ {gg}^{*} \vert i ] {R}_{gg}^{- 1} {R}_{hg}^{*}\end{matrix}$$

where R_{hh|g} is the covariance of the current channel conditioned on the source vector g.

Note that equation (7) is derived under the assumption of a complex Gaussian distributed channel side information. This is approximately true if the number of bits used for the quantization is high and the feedback channel is perfect. The transmission scheme is therefore suboptimal but still useful as the simulations discussed below will show. The optimal W is finally determined by

$$W = arg {min}_{{W}_{{‖ W ‖}_{F}^{2} = M}} v ( W ) \qquad ( 8 )$$

Algorithms for solving the optimization problem are described by Jöngren et al. in “Combining Transmit Beamforming and Orthogonal Space-Time Block Codes by Utilizing Side Information”, Proc. First IEEE Sensor Array and Multichannel Signal Processing Workshop, March 2000, which is herein incorporated by reference in its entirety.

The optimization problem can alternatively be solved off-line for each possible j and for each element of a suitably discretized subset of the model parameters. The resulting W matrices can then be stored in a lookup table at the transmitter. Consequently, the transmitter weighting can be viewed as a function W(j,Δ), where Δ denotes the model parameters for the assumed scenario. In this case, ĥ(j) and R_{hh|ĥ}(j) only serve as intermediate quantities used in the computation of the lookup table and need not be stored. Similar techniques can be utilized for implementing the encoder of the COVQ for storing the encoder centroids, as a function of the necessary model parameters in a lookup table.

The transmission scheme and also the design of the feedback link requires several parameters to be known. For example, if the simplified fading scenario is assumed, the variances σ², σₕ² and the correlation coefficient ρ and the BER of the feedback link must be known at the transmitter and W must be known at the receiver. In addition, σₕ², ρ and the bit-error probability of the feedback channel is needed in the design of the COVQ. It is possible to come up with several schemes for estimating these parameters and distributing them to where they are needed. For these estimation purposes, and in order to limit the number of model parameters, the simplified scenario can be an appropriate model assumption even though the actual environment does not satisfy all or any of the requirements (e.g., the fading could be spatially correlated). Another approach is to treat them as design parameters chosen such that they roughly match the conditions the system is operating in. However, in the simulations below, these parameters were assumed to be perfectly known.

In order to assess the benefits of utilizing transmit antenna weights in accordance with the present invention, simulations of the simplified scenario were performed. Throughout the simulations, two transmit antennas, one receive antenna and a corresponding orthogonal space-time block code were used. The elements of the codewords were taken from a binary phase shift keying (BPSK) constellation. The channel was constant during the transmission of a burst of codewords and independently fading from one burst to another. The SNR is defined as the sum of the average signal powers at all receive antennas, divided by the total noise power.

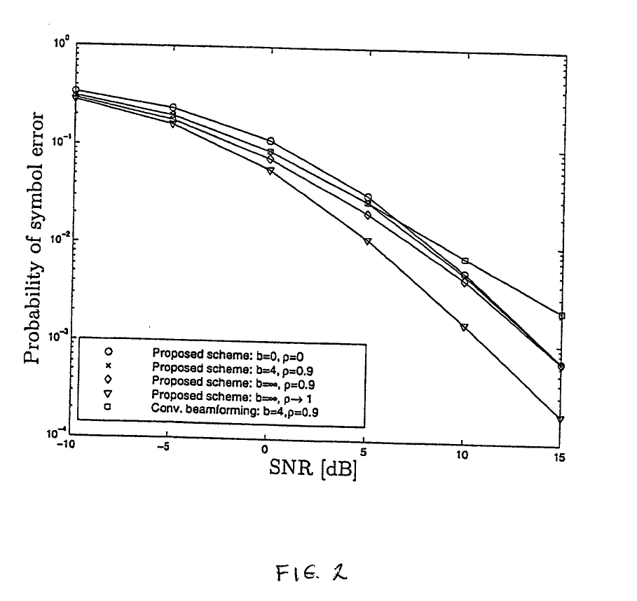

The probability of a symbol error as a function of the SNR was simulated using several values of ρ and b. The result is shown in FIG. 2 for a noise-free feedback channel, i.e., P_{b}=0. When ρ=0 or (b=0), no useful channel information is available and our scheme has the same performance as the corresponding open-loop system which employs the space-time code without modification. As the correlation coefficient increases, the performance is improved. The lowest error probability is obtained when ρ→1 and b→∞, which corresponds to perfect initial side information and no quantization. In this case, it can be shown that W has only one non-zero column, resulting in conventional beamforming. Next, consider the three remaining curves, simulated assuming ρ=0.9. The quality of the initial side information is thus fairly low. One of the curves shows the performance of a conventional beamformer when b=4. This kind of beamformer assumes that the channel estimates ĥ(j) are perfect. This gives good performance at low SNR values but as the SNR increases, the performance becomes even worse than the open-loop system. A comparison with the scheme of the present invention shows that the performance is similar at low SNR values but as the SNR increases, the scheme of the present invention is seen to perform significantly better. The performance of the open-loop system is in fact approached. Thus, the present invention combines the advantages of both beamforming and orthogonal space-time block coding. In order to show the impact of the quantization, simulations for ρ=0.9, b→∞ were also conducted.

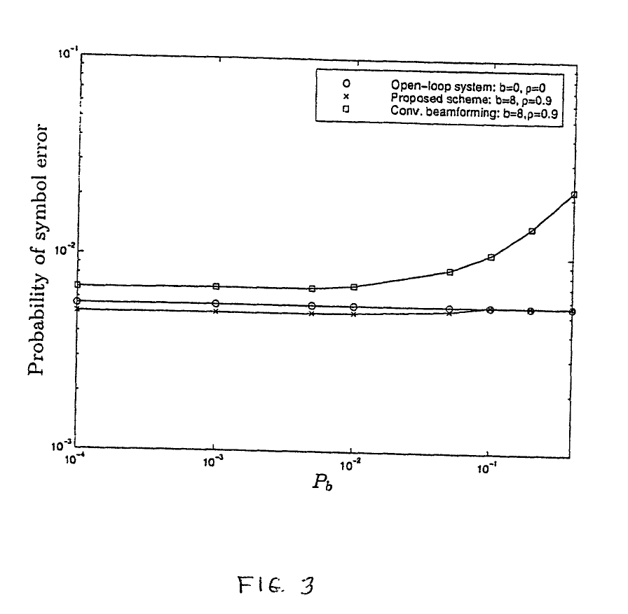

A comparison between the present invention and conventional beamforming for the case of a noisy feedback channel is illustrated in FIG. 3. The bit error probability of the feedback channel is varied while the SNR is kept constant at 10 dB. From this simulation it is apparent that the performance of the conventional beamformer quickly deteriorates as P_{b} is increased while the present invention slowly approaches the performance of the corresponding open-loop system. Accordingly, the present invention is much more robust to errors due to the feedback channel. However, as mentioned above, this comes at the price of estimating and distributing certain necessary parameters.

One possible application of the space-time coding scheme combined with feedback information is a soft handover scenario in the downlink of a CDMA system. In normal operation, the feedback information can be used as described above. However, in soft handover, the feedback provided to each transmitter should ideally reflect the channel from that particular transmitter only. As there typically are only one feedback channel, each transmitter cannot receive the feedback information it ideally needs. This can be taken into account by setting the channel reliability factor to zero.

The scheme of the present invention may also be motivated by current standardization proposals for the WCDMA system. For example, an orthogonal space-time block code is used in one of the proposed transmission modes, whereas one of the other proposed modes allows the receiver to inform the transmitter about the appropriate transmit antenna weights based on heavily quantized channel estimates.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

What is claimed is:

1. A method of utilizing feedback information in space-time coding, the method comprising:
mapping data to be transmitted into codewords which are split into a plurality of parallel and different symbol sequences;
deriving side information from initial side information which has been transmitted to the transmitter over a feedback link from a receiver; and
performing a linear transformation of the codewords based on side information obtained at the transmitter.

2. The method of claim 1, wherein channel information and a corresponding quality measure are derived from the side information.

3. The method of claim 2 further comprising:
quantizing the initial side information at the receiver prior to transmitting it over the feedback link to the transmitter.

4. The method of claim 3, wherein the linear transformation is represented by a matrix of transmitter weightings, and wherein the transmitter weightings are a function of the side information.

5. The method of claim 4, wherein the initial side information is quantized using a channel optimized vector quantizier (COVQ).

6. The method of claim 4, wherein the step of deriving side information comprises:
employing hard decoding of the output of the feedback link in the transceiver to obtain the side information.

7. The method of claim 6, wherein the transmitter weightings are calculated offline and stored in a lookup table.

8. The method of claim 7, wherein the transmitter weightings stored in the lookup table are derived from a criterion based on a pairwise error probability.

9. The method of claim 8, wherein the initial side information is quantized using a channel optimized vector quantizier (COVQ).

10. The method of claim 6, wherein the transmitter weightings are computed online using algorithms that utilize a criterion based on a pairwise error probability.

11. The method of claim 10, wherein the initial side information is quantized using a channel optimized vector quantizier (COVQ).

12. The method of claim 4, wherein the step of deriving side information comprises:
employing soft decoding of the output of the feedback link in the transceiver to obtain the side information.

13. The method of claim 12, wherein the transmitter weightings are computed online using algorithms that utilize a criterion based on a pairwise error probability.

14. The method of claim 13, wherein the initial side information is quantized using a channel optimized vector quantizier (COVQ).

15. A method of using quantized feedback in a transmission scheme, the method comprising:
quantizing initial side information at the receiver using a channel optimized vector quantizer (COVQ);
transmitting the quantized initial side information to the transmitter over a feedback link;
deriving side information from the quantized information received over the feedback link; and
mapping data to be transmitted into codewords based on the derived side information.

16. The method of claim 15, wherein the step of mapping the data to be transmitted further comprises:
performing a linear transformation of the codewords, wherein the linear transformation is represented by a matrix of transmitter weightings.

17. The method of claim 16, wherein the transmitter weightings are a function of the side information.

18. The method of claim 17, wherein channel information and a corresponding quality measure are derived from the side information.

19. The method of claim 18, wherein the codewords are split into a plurality of parallel and different symbol sequences.

20. The method of claim 19, wherein the step of deriving side information comprises:
employing hard decoding of the output of the feedback link in the transceiver to obtain the side information.

21. The method of claim 20, wherein the transmitter weightings are calculated offline and stored in a lookup table.

22. The method of claim 21, wherein the transmitter weightings stored in the lookup table are derived from a criterion based on a pairwise error probability.

23. The method of claim 20, wherein the transmitter weightings are computed online using algorithms that utilize a criterion based on a pairwise error probability.

24. The method of claim 19, wherein the step of deriving side information comprises:
employing soft decoding of the output of the feedback link in the transceiver to obtain the side information.

25. The method of claim 24, wherein the transmitter weightings are computed online using algorithms that utilize a criterion based on a pairwise error probability.

26. The method of claim 25, wherein the criterion minimizes an upper bound of the pairwise error probability.

27. A system for providing transmit spatial diversity, the system comprising:
a transmitter;
a receiver; and
a feedback link, wherein the transmitter is configured to:
decode quantized initial side information transmitted from the receiver over the feedback link;
derive channel information and a corresponding quality measure from the quantized initial side information; and
perform a linear transformation of the data to be transmitter based on the channel information and corresponding quality measure.

28. The system of claim 27, wherein the receiver is configured to utilizes a channel optimized vector quantizer in order to quantize and error protect the initial side information prior to transmission over the feedback link.
